(19) United States
(12) Patent Application Publication
(10) Pub. No.: US 2026/0010801 A1
(43) Pub. Date: Jan. 8, 2026

(54) Logic Gate Networks Generated Using Differentiable Logic Gate Models

(71) Applicant: Universität Konstanz, Konstanz (DE)

(72) Inventor: Felix Petersen, Santa Clara, CA (US)

(73) Assignee: Universität Konstanz, Konstanz (DE)

(21) Appl. No.: 19/301,717

(22) Filed: Aug. 15, 2025

Related U.S. Application Data
(63) Continuation of application No. 18/833,354, filed on Jul. 25, 2024.

(51) Int. Cl. G06N 3/0985

(52) U.S. Cl. CPC G06N 3/0985

(57) ABSTRACT

Systems and methods are described for training and deploying a logic gate neural network. In various examples, a computing system receives a training data set of input vectors with target outputs and instantiates an untrained network whose nodes are parameterized over a predefined set of potential logic operators. Training may include forward propagating a batch of input vectors, computing node outputs as differentiable functions of the potential operators, aggregating outputs by summation to form scores, evaluating a loss, and updating the differentiable parameters. A fixed network is defined after multiple iterations by selecting a single logic operator for each respective node. Examples of suitable logic operators include AND, OR, NAND, NOR, XOR, constants, inverters, direct connections, and the like. The fixed network can be implemented as an application-specific integrated circuit (ASIC) or stored in a non-transitory memory and implemented in programmable hardware, such as a field-programmable gate array (FPGA).

The technical field is artificial intelligence, particularly neural networks. Aspects relate to training a neural network to perform a machine learning task. The machine learning task may be a classification task or a regression task. The classification task may include one or more of the following: pattern and/or sequence recognition, novelty detection (i.e., outlier or anomaly detection), sequential decision-making. The regression task may include compression or decompression. In addition, aspects may relate to performing the machine learning task using the trained neural network.

A neural network may include artificial neurons (i.e., neurons, nodes, computation units, or units) and may be used for solving artificial intelligence problems. Connections between neurons may be modeled as weights in the neural network. The neural network may include parameters, which are components or elements of the neural network that can be trained. For example, the weights may be parameters in some neural networks. However, other parameters are also possible.

An activation function may be used to control the amplitude of the output of the neural network. Hence, the activation function may be used to restrict the value of the output of and add non-linearity to the neural network.

The neural network may be trained using an optimization algorithm. The training may include adjusting parameters of the neural network until the neural network is sufficiently accurate. The optimization algorithm may be based on (or rely on) gradient descent. Examples of optimization algorithms that are based on gradient descent include Stochastic Gradient Descent (SGD) and Adam (adaptive learning rate optimization algorithm—implemented as a combination of root mean squared propagation and SGD with momentum). Further information on Adam may be found in “Adam: A method for stochastic optimization”, Kingma et. al., 2014.

Gradient descent may be based on backpropagation (i.e., backprop or backward propagation). Gradient descent may include a cost function to measure the accuracy of the parameters and determine the direction in which a change of the parameters improves the network, i.e., so the parameters can be improved. Sufficient accuracy may be obtained when an output of the cost function is zero, at a minimum or within a specified range of zero. The specified range may depend on the machine learning task. In some cases, gradient descent (or an algorithm based on gradient descent) can only be used to train neural networks having parameters that are differentiable, such that binary or Boolean parameters cannot be trained via gradient descent. Boolean parameters (represented as 0 or 1 in the neural network) may lead to discontinuities (e.g., a jump from 0 to 1), where the gradient is undefined and gradient descent is not possible.

Accuracy of the neural network may be calculated in various ways. For example, in the context of the classification task, training error (or loss) may be obtained by measuring how accurately the neural network can classify data used to train the neural network. Classification loss (also referred to as generalization error or expected loss) may be obtained by measuring how accurately the neural network is able to perform the classification task on previously unseen data.

In some cases, the neural network may include multiple layers, i.e., at least one hidden layer and an output layer. In such cases, the neural network may be referred to as a deep learning neural network and there may be an unbounded number of hidden layers. Accordingly, multiple layers may be used to progressively extract higher-level features from an input. The neural network may be implemented as a feedforward network in which data flows from preceding hidden layers to the output layer without looping back. Initialization of the neural network may include assigning random weights to connections between the neurons.

Conventionally, if the neural network does not accurately perform the machine learning task, the weights are adjusted. In this way, influence of different neurons in the network can be calibrated until a suitable mathematical manipulation of the input for carrying out a machine learning task is determined.

Once trained to perform a machine learning task, the neural network may be used to perform the machine learning task. Performing the machine learning task may also be referred to as inference or performing inference.

Neural networks face various problems. For example, overfitting may occur when the training error is low but the classification loss is relatively high. In other words, the neural network learns an approach specific to training data used to train the neural network, which does not generalize well to other data different from the training data. Underfitting may occur if the neural network is not able to accurately capture a relationship between its input and its output, generating a high error rate on both the training data and other data.

While neural networks may be effective at performing classification tasks, they may be inefficient. Hence, various approaches to increasing the efficiency of neural networks have been developed.

For example, a conventional neural network may be a deep learning neural network including at least one dense layer, such that some or all of the neural network is fully connected; that is, each neuron in the dense layer receives input for all neurons of the previous layer. In this example, the neural network may be referred to as a densely connected neural network or a fully connected neural network.

In addition, the conventional neural network may employ floating-point computation with full precision weights and activations (e.g., double precision, that is, 64 bit), and commonly requires expensive matrix multiplications. Even with lower precision floating-point weights and activations (e.g., single precision or half precision), computation may still be expensive.

A binary neural network may differ from the conventional neural network in that 1-bit activations (and/or weights) replace the floating-point activations (and/or weights) of the conventional neural network. Hence, elements propagated through the network are binary, in the sense that they may have only one of two values, e.g., 0 or 1. Accordingly, in comparison to the conventional neural network, expensive matrix multiplication may be simplified to faster XNOR and bit count operations, which substantially improves inference performance of the binary neural network in comparison to the conventional neural network. In some cases, XNOR may be faster than bit count operations, and both may be faster than floating-point operations.

Floating point operations needed to train the neural network may be supported in the hardware of a computer. Specifically, a float32 adder and/or a float32 multiplier may require at least 1 000 logic gates (or look up tables) and may have a delay of tens of logical levels. Float32 adders and/or float32 multipliers may be implemented directly in a central processing unit (CPU) or a graphics processing unit (GPU). Nevertheless, the float32 adder and the float32 multiplier may require much more computational resources (e.g., processing cycles) than a bitwise logical operation on int64 data types, even on a GPU optimized for float32 and int32 data types. When the GPU is optimized for int32, int64 might not be efficiently supported. Hence, it may be more efficient to use int32 data types on such a GPU. In some hardware implementations, logical operations may be faster than addition and/or multiplication operations.

On CPUs, it may be that about 3 to about 10 int64 bit-wise operations can be performed per clock cycle, while floating-point operations usually require a full clock cycle (i.e., only one floating-point operation can be performed per clock cycle). Hence, the XNOR and bit count operations carried out when training the binary neural network may have a significant performance advantage compared to floating point operations carried out for the conventional neural network, even when the floating point operations (e.g., float32 adders or float32 multipliers) have specialized hardware support in the GPU or CPU. Considerations regarding floating point and integer operations may also be applicable to training the neural network for the machine learning task.

A convolutional neural network (CNN) may be a deep learning neural network in which at least one hidden layer has structured connections, i.e., is not fully connected. Accordingly, the CNN may perform convolutions, e.g., the hidden layer performs a dot product of a convolution kernel with an input matrix of the hidden layer. Hence it may be that only neurons of the hidden layer covered by the convolution kernel are connected to respective neuron of another layer in the CNN.

In conventional examples, the binary neural network may be based on a very deep convolutional neural network (e.g., VGG) architecture, which increases depth via very small (3×3) convolution filters, includes three fully connected layers and uses rectification nonlinearity (ReLU) to cut training time. Alternatively, the binary neural network may be based on a residual neural network (ResNet) architecture, which uses skip connections to jump over some layers. Both the VGG and ResNet architectures may result in very large neural networks, which may lead to inefficiencies.

The neural network may be sparse (in this example, a sparse neural network). Hence, the sparse neural network have a proper subset of the connections of a fully connected neural network. In other words, instead of fully connected layers, not all of the neurons in the layers of the sparse neural network are connected to each other. Sparseness may refer to the neural network's connectivity, such that each neuron receives inputs from only a limited number of other neurons, and/or to the neural network's state, which describes the level of activity of all the neurons in the neural network, such that not all neurons in the sparse neural network are active at any given time.

The sparse neural network may have less than 90% of the connections of the fully connected neural network, i.e., the sparse neural network may have a sparsity of at least 10% (sparsity between 10% and 70% may be referred to as low sparsity, sparsity between 70% and 90% as medium sparsity, sparsity between 90% and 99.9% as moderate sparsity and sparsity over 99.9% as high sparsity). A neural network having a sparsity under 10% may be referred to as dense.

The sparse neural network may be derived from the densely or fully connected neural network using a pruning or compression technique, e.g., a regularization technique. For example, one or more analysis methods or heuristics may be used to determine weights that to be retained and weights to be removed from the neural network (removing a weight may involve setting the weight to 0). More specifically, L1 or L2 regularization may be used to update a general cost function by adding a regularization term. As yet another example, dropout is a regularization technique in which random neurons in the neural network are canceled or removed. Dropout may be variational and may be limited by a boundary (e.g., a limit as to how many neurons are canceled). In some cases, rather than removing weights, neurons themselves may be removed from the neural network. Pruning techniques, as described above, may help avoid overfitting, thereby decreasing generalization error. Other techniques may involve removing entire layers of the neural network or adding an additional cost for relatively large weights of the neural network. Hence, sparse neural networks may provide improved accuracy (e.g., less overfitting) in comparison to dense neural networks. Sparse neural networks may also require less storage space in comparison to dense neural networks. However, in case the sparse neural network is derived by removing weights from a dense neural network, the sparse neural network may require more storage in order to store weight locations in addition to actual weights.

In the following two examples of conventional implementations, connectivity of the neural network may be relaxed.

In a first example, neurons of the neural network may be implemented as logic modules, where half of the logic modules are defined with a fuzzy (i.e., relaxed) conjunction and the other half are defined with a fuzzy (i.e., relaxed) disjunction. In this example, the parameters of the neural network include weights, while the operators (i.e., the fuzzy conjunctions and disjunctions) are fixed. Accordingly, the weights of neurons included in the fuzzy conjunctions and disjunctions may be relaxed from just 0 or 1 to values in a range from 0 to 1. In this way, parameters of the logic modules can be trained via gradient descent, unlike Boolean parameters.

In a second example, a set of arithmetic operations are predefined for each layer and implemented for the neurons of that layer. A form of softmax is used for learning and outputs of a previous layer are used as input of an arithmetic operation corresponding to the current layer. In this way, symbolic expressions can be learned from data.

In another conventional example, fully connected layers of an artificial neural network are replaced with sparse layers before training, quadratically reducing the number of parameters without substantially decreasing accuracy (e.g., without decreasing accuracy by more than 5% or by more than 10%). The sparse topology has two consecutive layers and is evolved into a scale-free topology during training. A scale-free topology is a sparse graph that approximates a power-law degree distribution P(d)˜d^{-y}, where the fraction P(d) from the total neurons of the network has d connections to other neurons, and the parameter γ usually stays in the range γ∈(2, 3).

In yet another conventional example, a single shared weight parameter is assigned to every connection in a neural network. Instead of optimizing weights, the neural network is optimized for network topologies that perform well over a wide range of weights. Neurons and connections are gradually added and activation functions (e.g., sin, cosine, Gaussian, tanh, sigmoid, inverse, absolute value, ReLU) are randomly assigned to new neurons. The activation functions evolve as the neural network grows. The neural network uses floating-point operators.

According to another conventional example, a method for memorizing binary classification data sets with a network of binary (2 input) lookup tables is provided. The network of the look up tables is constructed by counting conditional frequencies in training data (e.g., how many times a pattern p is associated with a particular output 0 in the training data). Like a neural network, the look up tables are arranged in successive layers. Unlike a neural network, training happens via memorization and does not involve back propagation or gradient descent. Memorization involves remembering an output that is most commonly associated with an input in the training data.

In a further conventional example, a neural network is first trained on a machine learning task and then the neural network is then translated into random forests, the random forests are then translated into networks of AND-Inverter logic gates, i.e., the networks are based on “AND” and “NOT” logic gates.

It may be desirable to provide a neural network for performing a machine learning task that is more efficient than the conventional examples described above, while maintaining comparable accuracy.

For example, a logic gate network may be used. The logic gate network may be a neural network in which each neuron includes a logic operator (i.e., a logic gate such as “AND” or “NAND”). Each logic operator may have between 0 and 2 inputs. The logic gate network is sparse in comparison to a fully-connected neural network, in which all neurons of a previous layer are provided as input to each neuron of a current layer. In other words, the logic gate network is sparse because rather than receiving n inputs, where n is the number of neurons per layer, each neuron of the logic gate network receives only two inputs. Accordingly, machine learning tasks may be performed efficiently since logic operations can be computed very fast (e.g., because logic operations are often built into the architecture of a processor). In addition, since each neuron has at most two inputs, the logic gate network is very sparse, e.g., at least medium sparsity, which may lead to improved accuracy in comparison to denser networks.

Optionally, the logic gate network may include at least one operator with 3 or more inputs.

Advantageously, the logic gate network might not require an activation function, since the logic gate network may operate on binary values (e.g., after training) and is nonlinear.

However, it may be problematic to implement a neural network as a logic gate network because conventional logic gate networks cannot be trained using an optimization algorithm based on gradient descent, such as SGD or Adam (described above). This is because values in the conventional logic gate network will always be 0 or 1. Hence, it is not possible to calculate a gradient in the conventional logic gate network because the loss function with respect to the parameters of a layer of the network has no derivative. Accordingly, it may be desirable to provide a logic gate network that can be trained using an optimization algorithm based on gradient descent.

Moreover, a conventional logic gate network may provide a single binary output (e.g., for the regression task) or k binary outputs for k classes (e.g., for the classification task). This does not allow for graded prediction, i.e., rating classes against each other. In other words, this does not allow for classification according to a “greatest activation” classification scheme (“How a Neural Network Works”, Arkin Gupta, May 27, 2018).

According to an aspect, a computer implemented method for training a neural network to perform a machine learning task is provided. The method comprises receiving input data for the neural network. The method further comprises determining values for a plurality of hyperparameters of the neural network. The method further comprises building the neural network according to the hyperparameter values, wherein the neural network comprises a plurality of neurons. Each neuron includes a probability distribution for a plurality of logic operators, such that the neuron includes a corresponding probability for each of the logic operators. The method further comprises training the neural network according to the hyperparameter values and the input data by learning the probability distribution of each neuron. The method further comprises determining a logic operator of the plurality of logic operators for each neuron by selecting a value in the probability distribution.

The neural network may be referred to as a binary neural network (because elements propagated in the network may only have one of two values once the neural network is trained), logic gate network (because the neurons implement logic operators) or a binary logic gate network. The logic operators may be referred to as logic gates.

In some cases, there are at most two inputs per neuron. When there are exactly two inputs per neuron and n neurons per layer, the neural network may have a sparsity of at most 1−(2/n).

The values of the plurality of hyperparameters may be determined from received hyperparameters (e.g., used for performance of a similar machine learning task or used by a similar neural network to perform the same machine learning task) or defined without receiving initial values.

In some cases, the probability distribution of each neuron may be a categorical probability distribution derived from multiple floating-point values, such that all entries in the probability distribution add up to 1 and are non-negative. The probability distribution may be derived from the floating-point values via softmax, such that the floating-point values map to the probability simplex thereby resulting in the categorical probability distribution. Since the probability distributions are trained, the probability distributions of the neural network may also be referred to as the parameters of the neural network.

The probabilities of the probability distribution may be ≥0 and ≤1.

Softmax may be a conventional function used to convert values into probabilities. Softmax may include a temperature (i.e., a temperature parameter), where the temperature may increase sensitivity to low probabilities. In other words, the temperature may be a way to control the entropy of the probability distribution (high temperature increases entropy, making the probability distribution more uniform, whereas low temperature decreases entropy and accentuates higher probabilities).

Selecting the value in the probability distribution may be implemented by selecting the most likely value or selecting a random value. More particularly, selecting the value may involve repeatedly selecting random values until a suitable value is found. In some cases, the selecting may include replacing the probability distribution with the mode of the probability distribution. Accordingly, in the trained neural network, the inputs and outputs of each neuron may be Boolean (0 or 1) and/or the operators of each neuron may be fixed (i.e., a single operator rather than a probability distribution).

Hence, the logic gate network can be trained by learning the probability distribution of each neuron, since use of the probability distributions enables calculation of a gradient that can be used to minimize the loss function. Accordingly, in comparison to the conventional logic gate network described above, a derivative of the loss function can be calculated and a gradient vector can be obtained. The derivative of the loss function is the direction in which the neural network improves. Therefore, being able to calculate the derivative of the loss function enables improvement of the neural network during training.

The input data may include inputs and corresponding desired outputs. The input data may include training data, validation data and test data. The training data, validation data and test data may be mutually exclusive or disjoint. In other words, none of the samples in the training data appear in the validation data or the test data, and none of the samples in the test data appear in the validation data or the training data. In this way, overfitting can be determined when evaluating the hyperparameters using the validation data and when testing the accuracy of the neural network using the test data. In some cases, it may be desirable to avoid overfitting. In other cases (sometimes referred to as benign overfitting), even when about 100% accuracy is achieved on the training data, the neural network may still be relatively accurate with respect to validation and test data. A sample may also be referred to as a data point.

In some cases, the training data may be used to train the neural network according to determined hyperparameter values. The validation data may be used to compare one set of determined hyperparameter values to another set of determined hyperparameter values. The test data may be used to determine the accuracy of the neural network when performing the machine learning task once final (e.g., most accurate) values for the hyperparameters have been determined.

The desired outputs may be referred to as labels. The input data may be provided as a set of tuples, where each tuple has the following form: (input or sample, corresponding output). Samples may be provided as fixed size vectors (e.g., binary vectors) or may have a known topological structure (e.g., an image).

In some cases, the hyperparameter values may be determined so as to minimize validation error of the neural network under one or more specified computational resource constraints, wherein the specified computational resource constraints may include processor and/or memory constraints.

There may be at least 5 hyperparameters or at least 10 hyperparameters. The hyperparameter values may determine the structure of the neural network and how the neural network is trained. The hyperparameters may affect the computing time and memory cost of inferences carried out via the neural network. In addition, the hyperparameters may affect the accuracy of the neural network. For example, too many neurons per layer may lead to overfitting while too few layers or neurons per layer may lead to underfitting.

In some cases, multiple sets of hyperparameter values may be determined and the neural network may be trained according to each set of the hyperparameter values. If sufficiently accurate, the most accurate of the trained neural networks may be used for inference.

The hyperparameter values (values for the plurality of hyperparameters) may be chosen randomly, via an optimization algorithm (e.g., a grid search or automated machine learning—AutoML) or via a random search. The optimization algorithm may be implemented using constraints provided by a user. The constraints may be dependent on the machine learning task. In the context of the grid search, the constraints may be referred to as a grid. The grid search may be carried out via a conventional grid search algorithm.

In some cases, the input data may include the training data and the validation data. Accordingly, for each set in the multiple sets of hyperparameter values, the neural network may be trained using the training data and a set of hyperparameter values and then the neural network may be validated for accuracy using the set of hyperparameter values and the validation data. The set of hyperparameter values having the lowest error with the validation data (i.e., the lowest validation error and the most accurate hyperparameter values) may be the determined hyperparameter values.

The hyperparameters may include one or more of the following: neurons per layer, number of layers, number of epochs, batch size, learning rate. In the context of the classification task, the hyperparameters may further include a softmax temperature for training the probability distribution. The softmax temperature may be used for increased as the number of neurons per layer is increased. Accordingly, the softmax temperature may depend on the number of outputs per class (e.g., the softmax temperature may be increased as the number of outputs per class increases).

The number of neurons per layer in the neural network may be determined according to the following constraints (e.g., selected from the following grid): {100, 1000, 10,000, 100,000, 1,000,000, 10,000,000}. The number of layers in the neural network may be determined according to the following constraints (e.g., selected from the following grid): {4, 5, 6, 7, 8}. Alternatively, a grid of {2, 3, 4, 5, 6, 7, 8, 9} may be used. A neural network having a smaller number of neurons may perform better for certain machine learning tasks, for example, classification tasks involving tabular data. In such cases, fewer neurons may help avoid overfitting. In contrast, more neurons (e.g., 64,000) may be better for image classification.

The softmax temperature may be determined according to the following constraints (e.g., selected from the following grid): {1, 3, 10, 30, 100}. Alternatively, the grid of {1, 1/0.3, 1/0.1, 1/0.03, 1/0.01} may be used. Increasing the softmax temperature as the number of neurons per layer is increased may improve performance. For example, if the number of neurons per layer is 2000 to 10,000, a softmax temperature of about 10 may lead to an accurate neural network (a low validation error) in comparison to other softmax temperature values. If the number of neurons per layer is 12,000 to 100,000, a softmax temperature of about 30 may lead to an accurate neural network. If the number of neurons per layer is more than 100,000, a softmax temperature of about 100 may lead to an accurate neural network. If the number of neurons per layer is 100, a softmax temperature of less than 3 (e.g., 1 or 3) may lead to an accurate neural network.

Training the neural network according to the hyperparameter values may comprise training for the number of epochs at the batch size with the learning rate.

The number of epochs may be the number of times all of the training data is shown to the neural network (e.g., provided as input to the neural network) while training. For example, when determining the hyperparameters, the number of epochs may be increased until the validation error starts increasing even when training error is decreasing (overfitting). A suitable value for the number of epochs may be about 200.

The batch size may refer to the number of samples (i.e., instances, observations, input vectors or feature vectors) from the input data propagated through the neural network per training iteration. For example, in the context of the classification task of image classification, each sample of the input data may include an image and a label for the image. Possible values for the batch size may be 32, 64, 128, 256, and other powers of two. In some cases, a batch size of about 100 may be used.

The learning rate may specify how much to change the neural network in response to the validation error for each epoch. In setting the learning rate, there may be a trade-off between rate of convergence to low validation error and increasing training error during training. The learning rate may be determined according to the following constraints (e.g., selected from the following grid): {0.1, 0.01, 10⁻³ 10⁻⁴, 10⁻⁵}. For example, a learning rate of about 0.01 may be used.

Training the neural network may comprise continuously parameterizing the probability distributions. Hence, the probability distribution of each neuron may be parameterized during training (e.g., using softmax to independently select elements from a standard normal distribution). For example, a result may be computed from each probability distribution in the neural network, e.g., the result may be computed during each epoch (i.e., each stage of learning). The result may be an average, a weighted average or another statistical function of the probability distribution.

The neural network may include multiple layers, the multiple layers including an output layer. The neural network may include at least one hidden layer. At least one layer (e.g., the hidden layer) may precede the output layer. Input to the neural network may be accessed by a first layer, e.g., a first one of multiple hidden layers.

In the case of multiple hidden layers, each of the hidden layers may have the same number of neurons.

The neural network may have the same number of neurons in the hidden layer and the output layer. In addition or alternatively, the neural network may have between four and eight layers.

When the machine learning task is a classification task, the classification task may have at least two classes. In some cases, the number of neurons per layer may be selected such that each class of the classification task is associated with multiple neurons of the output layer. Accordingly, by using multiple neurons per class and aggregating them by summation, graded classification can be performed, with as many grades (levels) as there are neurons per class. Each of the neurons in a class could capture a different piece of evidence (or aspect) of the class, allowing for finer grade classification in comparison to a conventional logic gate network.

The method may further comprise performing the machine learning task using the trained neural network, after determining the logic operator for each neuron. In the case of the classification task, the output layer may include n neurons and the classification task may have k classes. Accordingly, performing the classification task using the trained neural network may comprise:
outputting, by the trained neural network a classification score for each of the classes,
grouping the output into k groups of size n/k, where the number of 1s in each group corresponds to a classification score for a class corresponding to the group,
determining a classification, comprising determining a maximum of the classification scores.
   Determining the maximum of the classification scores may include using an operation to determine the class with the largest probability (i.e., the largest predicted probability). Accordingly, the maximum of the classification scores may be determined using an argmax operation.

In some cases, output bits for each class (i.e., for each classification score) may be aggregated into a binary number to reduce the required memory bandwidth for returning the predictions (i.e., classification scores). This may be expressed via a fixed logic gate network. Specifically, adders may be implemented, which can add one bit to a binary number with logic gates. Accordingly, an adder may be implemented for each classification score, such that the number of adders corresponds to the number of classification scores. The adders may be modified, such that they are suitable for adding up the output bits of a corresponding class into an integer. This way, the aggregation is extremely efficient, specifically, the aggregation is faster than storing the un-aggregated results in VRAM.

After determining the logic operator for each neuron and before outputting the classification score, the method may further comprise converting the trained neural network into a binary executable on a central processing unit (CPU) or a graphics processing unit (GPU). In some cases, the executable binary is callable via a program that can handle shared object binaries, e.g., Python. The binary that is executable on the CPU may be compiled from C code. The binary that is executable on the GPU may be compiled from CUDA (previously Compute Unified Device Architecture).

The inputs and outputs of the neurons may be real-valued.

In some cases, during the training, the outputs of all the neurons may be values in a range from 0 to 1 (i.e., greater than or equal to 0 and less than or equal to 1). Similarly, the inputs to the neurons may be greater than or equal to 0 and less than or equal to 1. In addition or alternatively, each neuron may receive between 0 and 3 inputs. More specifically, each neuron may receive between 0 and 2 inputs. For example, the “0” operator may receive 0 inputs, the “A” operator may receive only 1 input and the “A-AB” operator may receive 2 inputs.

Building the neural network may further comprise pseudo-randomly initializing connections between the neurons (i.e., weights of the neural network). The pseudorandom initialization may have the advantage that the connections do not need to be stored but can be generated as needed. In particular, the connections may be produced from a seed (i.e., a random seed used to initialize a pseudorandom number generator) and reproduced from the same seed. The seed may be generated from a state of a computer (e.g., time) or from a hardware-based special-purpose random number generator. Building the neural network may also comprise initializing the connections using other heuristics, e.g., pseudo-randomly within groups, or a structure that allows faster computation on specific hardware.

Accordingly, once the neural network is trained, storing the neural network merely requires storing the four bit information specifying which logic operator is used for each neuron. In other words, storing the neural network may require n×4 bits (where n is the number of neurons in the neural network), plus relatively low constant values. The constant values may include (e.g., may be limited to) the seed and the size of the layers (number of inputs and number of outputs). When the size of the layers is the same (i.e., all layers have the same size), then only one size value is needed. In this way, the storage requirements for the neural network may be significantly lower than conventional neural networks (e.g., dense neural networks, convolutional neural networks, sparse neural networks or even binary neural networks).

During the training connections between the neurons may remain fixed. In other words, it may be that the neural network is not trained by adjusting weights of the neurons.

The classification task may include one or more of the following: binary classification, pattern recognition (e.g., feature classification), image classification, object identification or recognition, character recognition, gesture or facial recognition, voice detection or speech recognition, text classification.

For example, the input data for a binary classification task may include binary vectors of size 17. Each of the binary vectors may be classified into class 0 or class 1. In another example, input data for a pattern recognition (specifically, image classification) task may include images of digits from 0 to 9 as well as a corresponding label for each of the images. Each of the images may be classified by identifying which digit the image corresponds to.

Binary classification may include one of the following: medical testing (to determine whether a patient has a disease), quality control (determining whether a technical specification has been met) and information retrieval (determining whether a page should be in the result set of a search).

Pattern recognition may include image processing (e.g., image classification). Pattern recognition may be used for one of the following: identification and/or authentication, medical diagnosis, defense, and mobility. Identification and/or authentication may include license plate recognition, fingerprint analysis, facial recognition, voice-based authentication. Medical diagnosis may include screening for cervical cancer, breast tumors or heart sounds. Defense may include navigation and guidance systems, target recognition systems, shape recognition technology. Mobility may include driver assistance systems (to assist with driving and parking) and/or autonomous vehicle technology (for a ground vehicle capable of moving safely with little or no human input).

The machine learning task may be a regression task, wherein the regression task may comprise one or more of the following: generating an image, generating text, generating a video, generating speech, 3D reconstruction, compression, encoding. In particular, the regression task may include video, audio or image compression. The encoding may include speech encoding.

Training the neural network may further comprise determining whether the neural network is sufficiently accurate by comparing an accuracy of the neural network to a specified accuracy. Training is carried out in a differentiable manner, i.e., the probability distribution of logic operators for the neurons in the neural network is learned during training. Hence training includes determining a loss or error of neuron probability distributions. In contrast to training, inference (i.e., use of the trained neural network) does not need to be differentiable and can be carried out using fixed logic operators and hard (0 or 1) rather than relaxed (a probability from 0 to 1) values.

The accuracy of the neural network may be determined conventionally using a conventional loss function. For example, a softmax cross-entropy classification loss function may be used. In this context, cross entropy is a divergence measure of the difference between two probability distributions. As an alternative, mean squared error loss may be used for regression.

The specified accuracy may be determined according to the machine learning task. For example, the specified accuracy for binary classification may be about 100%, while the specified accuracy for image classification may be at least 95% or at least 97%.

Training the neural network may further comprise, when the neural network is not sufficiently accurate, determining new values for the hyperparameters. The new values for the hyperparameters may be iteratively determined, e.g., using Bayesian optimization. Accordingly, the neural network may be rebuilt according to the new values and the rebuilt neural network may be trained according to the new values. After performing a specified number of iterations (or when the specified accuracy is reached), a most accurate neural network may be determined from the neural network and the rebuilt neural networks. The most accurate neural network may be provided as the trained neural network.

There may be a trade-off between accuracy and efficiency. In particular, a neural network including more neurons may not be as efficient in inference. Therefore, it may be desirable to reduce the specified accuracy in the interest of efficiency. In addition, knowledge from previous iterations may be used to determine new hyperparameter values for subsequent iterations. For example, the constraints for determining the hyperparameter values may be modified.

In some examples, the plurality of logic operators may include at least 2 operators, at least 8 operators or exactly 16 operators.

In some examples, the plurality of logic operators may be real-valued (i.e., relaxed counterparts of logic gates).

The logic operators may conform to one of the following interpretations: probabilistic, Hamacher t-norm, relativistic Einstein sum t-conorm, Lukasiewicz t-norm and t-conorm.

The real-valued logic operators may be derived from fuzzy logic.

The t-norm may be a binary operation used in fuzzy logic to represent a conjunction. Similarly, the t-conorm may be used to represent a disjunction in fuzzy logic.

Use of real-valued logic operators and/or real-valued inputs may contribute to making the neural network differentiable. Conventional logic gate networks are not differentiable because their parameters are limited to 0 and 1. Use of real values may enable calculation of the gradient as a derivative (e.g., multi-dimensional derivative) of the loss function with respect to the network parameters, since use of real values eliminates discontinuities, e.g., jumps from 0 to 1. Accordingly, the neural network may be referred to as a differentiable logic gate network. Making the neural network differentiable may facilitate training using an algorithm based on gradient-descent.

Moreover, the inputs and outputs of the neurons may be real-valued during training but Boolean (fixed) in the trained neural network. Similarly, the logic operators of the trained neural network may be discretized by taking their mode, such that each probability distribution is replaced by the logic operator having the highest value in the probability distribution.

The real-valued logic operators may include the following:

$$0 , A \cdot B , A - AB , A ,$$

$$B - AB , B , A + B - 2 AB , A + B - AB ,$$

$$1 - ( A + B - AB ) , 1 - ( A + B - 2 AB ) , 1 - B , 1 - B + AB ,$$

$$1 - A , 1 - A + AB , 1 - AB , 1.$$

In the real-valued logic operators above A and B may be inputs from corresponding neurons. In other words, the real-valued logic operator of a given neuron may perform an operation on an input A from a first neuron and an input B from a second neuron. In the cases of 0 and 1, these values may be output regardless of the input. The real-valued logic operators above may correspond to the probabilistic interpretation (i.e., the probabilistic product T-norm and the probabilistic sum T-conorm). However, other interpretations (as listed above) may also be used.

In some cases, the input data may include test data having a plurality of samples. The method may further comprise, during inference (i.e., after the training), performing the machine learning task by accessing an aggregation of the test data by a first layer of the neural network, the accessing comprising assigning the elements of each sample of the test data to successive bits of the integers. Accordingly, during inference (i.e., after the training), the two inputs of each neuron have a numeric data type corresponding to a hardware-implemented data type of a processor of a computer on which the machine learning task is to be performed.

Accordingly, the aggregation of the test data may have an aggregation size, i.e., the aggregation size of the batch during inference. The aggregation size corresponds to the hardware-implemented data type of the processor (i.e., an assembly language data type), and is therefore efficient. For example, an aggregation size of 64 could be used for an int64 hardware-implemented data type and an aggregation size of 32 for an int32 hardware-implemented data type.

Specifically, the samples of the test data may be images and elements of the samples may be pixels of the images. The numeric data type may be an integer data type, e.g., int64, rather than the Boolean data type conventionally used with binary neural networks. Hence, each neuron input may be part of an int64 integer, such that the entire integer consists of 64 different neuron inputs. The aggregation size may be 64. Accordingly, each batch of images provided for the machine learning task may include 64 images, each image having 784 binary pixels (i.e., 28×28 bitmap images), such that the images can be batched into (i.e., spread across) an array of 784 integer variables, each having the hardware-implemented data type of int64. The processor of the computer on which the machine learning task is to be performed may be a CPU or a GPU.

Accessing the test data by neurons of the first layer may correspond to spreading the test data across neurons of the first layer. The accessing may include assigning (all) the values of image 1 to bit 1 of the integers and (all) the values of image 2 to bit 2 of the integers, such that each successive image is spread across all the integers of the first layer. Put another way, the Boolean value i of the image k may be assigned to bit k of int64 value i.

Accordingly, all logical operations are executed on the integers since the operations are the same for each image. Hence, bitwise operators can be applied to 64 bits of an int64 at the same time, usually at the same (or comparable) processing cost to applying the bitwise operators to a single value having the Boolean data type.

In this way, performance can be significantly improved in comparison to performance of operations on values having the Boolean data type. In particular, this performance improvement relies on the fact that on many processors (e.g., many if not most CPUs) performing a bitwise operation on a value having the Boolean data type and a value having an integer data type corresponding to a hardware-implemented data type of the processor (e.g., the int64 data type) effectively takes the same amount of time, i.e., it requires one instruction. Further efficiencies may be realized by using data types larger than int64, for example, using an Advanced Vector Extensions (e.g., AVX, AVX2, AVX-512) instruction set.

As an alternative to a CPU or GPU, specialized hardware may be used, e.g., an ASIC or an FPGA. In this case, the Boolean data type may be efficiently used.

According to another aspect, a computer program is provided. The computer program comprises instructions that, when the program is executed by a computer, cause the computer to carry out a method as described above. The computer program may be part of (or included in) a computer program product. The computer program may be (tangibly) embodied in a computer readable medium. The computer program may be implemented in hardware or software. In particular, the computer program may be implemented using an FPGA or an ASIC. In addition or alternatively, the computer program may be implemented in a processor (CPU or GPU) component including hardware encoding (e.g., the FPGA or the ASIC) implementing a neural network to carry out a specific task.

According to yet another aspect, a computer system for training a neural network to perform a machine learning task is provided. The computer system comprises at least one processor. The processor is configured to receive input data for the neural network, determine values for a plurality of hyperparameters of the neural network and build the neural network according to the hyperparameter values. The neural network comprises a plurality of neurons. Each neuron includes a probability distribution for a plurality of logic operators, such that the neuron includes a corresponding probability for each of the logic operators. The processor is further configured to train the neural network according to the hyperparameter values and the input data by learning the probability distribution of each neuron. The processor is further configured to determine a logic operator of the plurality of logic operators for each neuron by selecting a value in the probability distribution.

The processor may be a GPU including features that can be exploited to accelerate training of the neural network to perform the machine learning task (using techniques of the present disclosure) or to accelerate performance of the machine learning task.

In addition or alternatively, the computer system may be implemented using at least one FPGA and/or ASIC.

In addition or alternatively, the computer system may include hardware acceleration (e.g., in an ASIC) for a logic gate network.

The subject matter described in this disclosure can be implemented as a method or on a device, possibly in the form of one or more computer programs (e.g., computer program products). Such computer programs may cause a data processing apparatus to perform one or more operations described in the present disclosure.

The subject matter described in the present disclosure can be implemented in a data signal or on a machine readable medium, where the medium is embodied in one or more information carriers, such as a tape, CD-ROM, a DVD-ROM, a semiconductor memory, or a hard disk. In particular, disclosed subject matter may be tangibly embodied in a machine (computer) readable medium.

In addition, the subject matter described in the present disclosure can be implemented as a system including a at least one processor, and a memory coupled to the processor. The processor may be a central processing unit (CPU) or a graphics processing unit (GPU). The memory may encode one or more programs to cause the processor to perform one or more of the methods described in the application. Further subject matter described in the present disclosure can be implemented using various machines. The CPU and/or the GPU may include integrated circuits with hardware acceleration, e.g., hardware acceleration for floating-point arithmetic. Alternatively, the processor may be general-purpose hardware without hardware acceleration (e.g., floating-point acceleration).

Moreover, subject matter in this disclosure may be implemented on at least one field-programmable gate array (FPGA). The FPGA may be specially designed for artificial intelligence, and/or particularly for implementing a neural network. The FPGA may be a configurable hardware accelerated processor that can perform a predefined task (or set of tasks) efficiently, when the predefined task is expressed via logic gates. The FPGA may be particularly suitable for tasks where the complexity is limited while high speeds are necessary, such as mining crypto currency (e.g. Bitcoin) or implementing an oscilloscope. Accordingly, for operations on a neural network, an FPGA specially designed for processing the neural network may be 10 to 100 times faster than a conventional CPU.

In addition or alternatively, subject matter in this disclosure may be implemented using an application specific integrated circuit (ASIC) customized for a particular use. For example, the ASIC may be developed to support artificial intelligence. Specifically, Google's Tensor Processing Unit or Fujitsu's Deep Leaming Unit may be used.

In addition or alternatively, a hardware implementation of a logic gate network may be used. Specifically, an FPGA or ASIC may be used to implement the logic gate network, or a GPU may include features that can be exploited to accelerate training of a neural network to perform a machine learning task (using techniques of the present disclosure) or to accelerate performance of the machine learning task.

Details of one or more implementations are set forth in the exemplary drawings and description that follow. Other features will be apparent from the description, the drawings, and from the claims.

### BRIEF DESCRIPTION OF THE FIGURES

FIG. 1 shows a simplified neural network including inputs, two hidden layers and an output layer.

FIG. 2 shows another simplified neural network.

FIG. 3 shows steps of a method for training a neural network to perform a machine learning task.

FIGS. 4A, 4B, 4C, and 4D show shows a distributions of logic operators in each layer of a four layer neural network after training.

### DETAILED DESCRIPTION

In the following text, a detailed description of examples will be given with reference to the drawings. Various modifications to the examples may be made. In particular, one or more elements of one example may be combined and used in other examples to form new examples.

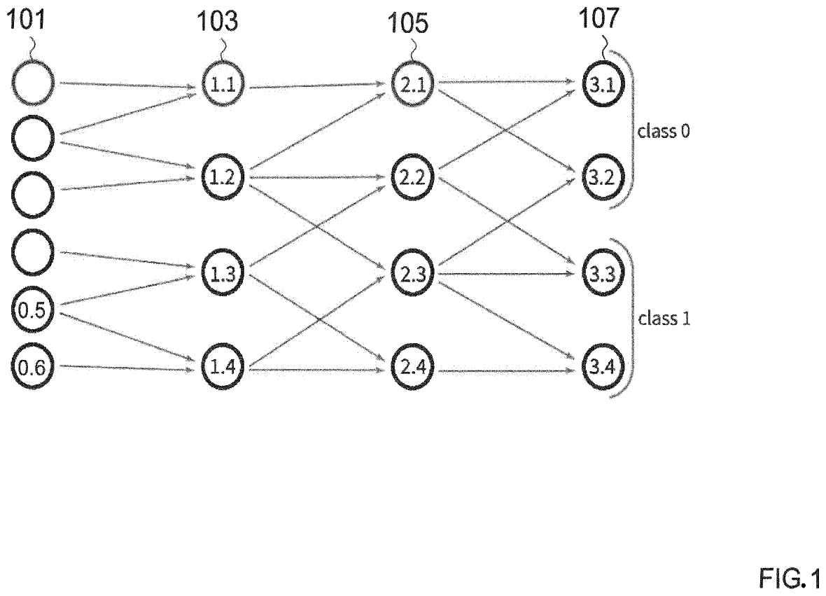

FIG. 1 shows an exemplary neural network for performing a machine learning task. More specifically, the neural network is for performing a classification task. The neural network may be built according to determined hyperparameter values. Hence, the hyperparameter values may define a structure of the neural network. The hyperparameter values may include a number of layers and a number of neurons per layer. Thus, the neural network may be built according to the hyperparameters, such that the neural network includes inputs 101, a first layer 103, a second layer 105 and an output layer 107. Further, the output layer 107 includes four neurons. In addition, each of the layers 103 and 105 includes four neurons.

Hence, the layers 103 and 105 and the output layer 107 of the neural network may each include the same number of neurons. Put another way, the layers of the neural network may each include the same number of neurons.

The classification task of the simplified neural network has two classes, class 0 and class 1. Hence, the classification task comprises binary classification. For example, neurons 3.1 and 3.2 may each output “1” and neurons 3.3 and 3.4 may each output “0”. In this case, the number of classes k is 2 and the number of neurons n in the outer layer 107 is 4, so that the output can be grouped into 2 groups of size 2. Accordingly, a classification score for class 0 would be 2 and classification score for class 1 would be 0. Hence, determining the classification according to a maximum of the classification scores would result in determining class 0 as the classification. In other examples, more classes may be used.

Each neuron 1.1 to 3.4 in the neural network receives two inputs from two different neurons. For example, a neuron 1.4 in the first layer 103 receives inputs 0.5 and 0.6 of the inputs 101.

Each neuron may include a corresponding probability for each of the plurality of logic operators. The probabilities of a neuron may be part of a probability distribution of the neuron, which may be learned as the neural network is trained. The logic operators may be real-valued (i.e. relaxed). The real-valued logic operators may be based on T-norms (a relaxation of “and”) and T-conorms (a relaxation of “or”). The real-valued logic operators may be differentiable and/or continuous. Accordingly, it may be that neither the drastic T-Norm nor the minimum T-Norm provide an adequate basis for the real valued logic operators.

The real-valued logic operators may be seen as extensions to conventional Boolean logic operators in that the real-valued logic operators are defined not only on inputs of 0 and 1, but also on inputs between 0 and 1.

An exemplary probability distribution for neuron 1.1 of layer 103 may include the following probabilities, as shown in table 1:

TABLE 1

| AND | OR | NAND | NOR | XOR | . . . | TRUE | FALSE |
|---|---|---|---|---|---|---|---|
| 3% | 1% | 7% | 2% | 72% | | 9% | 1% |

Table 2 shows a probabilistic interpretation of the real valued logic operators (probabilistic logic operators) and their corresponding Boolean interpretations:

TABLE 2

| ID | Operator | real-valued | 00 | 01 | 10 | 11 |
|---|---|---|---|---|---|---|
| 0 | False | 0 | 0 | 0 | 0 | 0 |
| 1 | A ∧ B | A · B | 0 | 0 | 0 | 1 |
| 2 | ¬(A ⇒ B) | A − AB | 0 | 0 | 1 | 0 |
| 3 | A | A | 0 | 0 | 1 | 1 |
| 4 | ¬(A ⇐ B) | B − AB | 0 | 1 | 0 | 0 |
| 5 | B | B | 0 | 1 | 0 | 1 |
| 6 | A ⊕ B | A + B − 2AB | 0 | 1 | 1 | 0 |
| 7 | A ∨ B | A + B − AB | 0 | 1 | 1 | 1 |
| 8 | ¬(A ∨ B) | 1 − (A + B − AB) | 1 | 0 | 0 | 0 |
| 9 | ¬(A ⊕ B) | 1 − (A + B − 2AB) | 1 | 0 | 0 | 1 |
| 10 | ¬B | 1 − B | 1 | 0 | 1 | 0 |
| 11 | A ⇐ B | 1 − B + AB | 1 | 0 | 1 | 1 |
| 12 | ¬A | 1 −A | 1 | 1 | 0 | 0 |
| 13 | A ⇒ B | 1 − A + AB | 1 | 1 | 0 | 1 |
| 14 | ¬(A ∧ B) | 1 − AB | 1 | 1 | 1 | 0 |
| 15 | True | 1 | 1 | 1 | 1 | 1 |

In Table 2, the ID column identifies each row. The operator column shows a Boolean operator. A row of the real-valued column shows a real-valued operator corresponding to the Boolean operator in the row. Rows of the columns “00”, “01”, “10”, “11” show the output of the operator (Boolean or real-valued) corresponding to that row, given the header value (e.g., “00”) of the column as input. Testing has shown that reducing the number of operators in table 2 may lead to decreased performance. In other words, use of 16 logic operators, as opposed to less than 16 logic operators, may improve the efficiency of the method for training a neural network to perform a machine learning task.

The values in table 2 show the probabilistic logic operators. Other interpretations may also be used for the real-valued logic operators. For example, the Hamacher product T-Norm and its dual, the Einstein sum T-conorm may be differentiable and provide a suitable basis for the real-valued logic operators. Real valued logic operators based on the Hamacher product T-Norm and the Einstein sum T-conorm are shown in table 3 below.

TABLE 3

| ID | Boolean operator | Hamacher/Einstein operator |
|---|---|---|
| 0 | False | 0 |
| 1 | A ∧ B | A · B/(A + B − A · B) |
| 2 | ¬(A ⇒ B) | (1 − A) ∧ (B) |
| 3 | A | A |
| 4 | ¬(B ⇒ A) | (A) ∧ (1 − B) |
| 5 | B | B |
| 6 | A ⊕ B | (A ∨ B) ∧ ¬(A ∧ B) |
| 7 | A ∨ B | A + B/(1 + A · B) |
| 8 | ¬(A ∨ B) | 1 − (A + B)/(1 + A · B) |
| 9 | ¬(A ⊕ B) | 1 − ((A ∨ B) ∧ ¬(A ∧ B)) |
| 10 | ¬B | 1 − B |
| 11 | A ⇐ B | ¬A ∨ B |
| 12 | ¬A | 1 − A |
| 13 | A ⇒ B | ¬B ∨ A |
| 14 | ¬(A ∧ B) | 1 − A · B/(A + B − A · B) |
| 15 | True | 1 |

Some operators in table 3 can be derived from other operators in table 3. In table 3, rows 2, 4, and 9 the respective Boolean operator has no corresponding real-valued operator. For the implications (rows 2 and 4 in table 3), an R-implication (or residium) corresponding to a T-Norm may be used (see “Continuous R-implications”, B. Jayaram et al., Jul. 20-24, 2009). The probabilistic operators of table 2 have been found to perform better than the Hamacher T-Norm and Einstein sum T-conorm of table 3 in testing.

Other implementations of real-valued operators may be based on Frank T-norms, Yager T-norms, Aczél-Alsina T-norms, Dombi T-norms, and Sugeno-Weber T-norms in addition to their corresponding T-conorms. More information regarding logic operators can be found in “Analyzing Differentiable Fuzzy Logic Operators”, van Krieken et al., Aug. 24, 2021.

Further T-norms and T-conorms that may be used to implement real-valued operators are shown in tables 4 and 5 below:

TABLE 4

| | |
|---|---|
| Minimum | ${⊤}^{M} ( a , b ) = min ( a , b )$ |
| Probabilistic | ${⊤}^{P} ( a , b ) = a b$ |
| Einstein | ${⊤}^{E} ( a , b ) = \frac{ab}{2 - a - b + ab}$ |
| Hamacher | ${⊤}_{p}^{H} ( a , b ) = \frac{ab}{p + ( 1 - p ) ( a + b - ab )}$ |
| Frank | ${⊤}_{p}^{F} ( a , b ) = {log}_{p} ( 1 + \frac{( {p}^{a} - 1 ) ( {p}^{b} - 1 )}{p - 1} )$ |
| Yager | ${⊤}_{p}^{Y} ( a , b ) = max ( 0 , 1 - {( {( 1 - a )}^{p} + {( 1 - b )}^{p} )}^{\frac{1}{p}} )$ |
| Aczél-Alsina | ${⊤}_{p}^{A} ( a , b ) = exp ( - {( {\vert log ( a ) \vert}^{p} + {\vert log ( b ) \vert}^{p} )}^{\frac{1}{p}} )$ |
| Dombi | ${⊤}_{p}^{D} ( a , b ) = {( 1 + {( {( \frac{1 - a}{a} )}^{p} + {( \frac{1 - b}{b} )}^{p} )}^{\frac{1}{p}} )}^{- 1}$ |
| Schweizer-Sklar | ${⊤}_{p}^{S} ( a , b ) = {( {a}^{p} + {b}^{p} - 1 )}^{\frac{1}{p}}$ |

TABLE 5

| | |
|---|---|
| Maximum | ${⊥}^{M} ( a , b ) = max ( a , b )$ |
| Probabilistic | ${⊥}^{P} ( a , b ) = a + b - ab$ |
| Einstein | ${⊥}^{E} ( a , b ) = {⊥}_{2}^{H} ( a , b ) = \frac{a + b}{1 + ab}$ |
| Hamacher | ${⊥}_{p}^{H} ( a , b ) = \frac{a + b + ( p - 2 ) ab}{1 + ( p - 1 ) ab}$ |
| Frank | ${⊥}_{p}^{F} ( a , b ) = 1 - {log}_{p} ( 1 + \frac{( {p}^{1 - a} - 1 ) ( {p}^{1 - b} - 1 )}{p - 1} )$ |
| Yager | ${⊥}_{p}^{Y} ( a , b ) = min ( 1 , {( {a}^{p} + {b}^{p} )}^{\frac{1}{p}} )$ |
| Aczél-Alsina | ${⊥}_{p}^{A} ( a , b ) = 1 - exp ( - {( {\vert log ( 1 - a ) \vert}^{p} + {\vert log ( 1 - b ) \vert}^{p} )}^{\frac{1}{p}} )$ |
| Dombi | ${⊥}_{p}^{D} ( a , b ) = {( 1 + {( {( \frac{1 - a}{a} )}^{p} + {( \frac{1 - b}{b} )}^{p} )}^{- \frac{1}{p}} )}^{- 1}$ |
| Schweizer-Sklar | ${⊥}_{p}^{S} ( a , b ) = 1 - {( {( 1 - a )}^{p} + {( 1 - b )}^{p} - 1 )}^{\frac{1}{p}}$ |

Exemplary values for the neurons of FIG. 1 during training are provided in the tables below.

### Logic Operator Probabilities in the Middle of Training the Neural Network

----------------------------------------------------------------------------------------------------
----------------------------------------------------------------------------------------------------
1.1: 0.000 0.000 0.696 0.273 0.000 0.000 0.008 0.009 0.000 0.001 0.003 0.006 0.000 0.002 0.001 0.001
1.2: 0.002 0.001 0.004 0.001 0.001 0.000 0.000 0.000 0.005 0.020 0.641 0.320 0.002 0.000 0.002 0.001
1.3: 0.000 0.001 0.001 0.003 0.001 0.002 0.860 0.128 0.001 0.000 0.000 0.000 0.001 0.002 0.000 0.001
1.4: 0.000 0.000 0.000 0.000 0.000 0.001 0.017 0.419 0.000 0.000 0.000 0.000 0.000 0.000 0.517 0.044
----------------------------------------------------------------------------------------------------
2.1: 0.000 0.000 0.001 0.000 0.423 0.000 0.029 0.000 0.003 0.000 0.002 0.000 0.352 0.001 0.189 0.000
2.2: 0.012 0.008 0.032 0.024 0.787 0.058 0.014 0.036 0.007 0.001 0.001 0.001 0.006 0.009 0.003 0.001
2.3: 0.000 0.004 0.000 0.001 0.001 0.004 0.001 0.001 0.001 0.915 0.000 0.002 0.001 0.067 0.000 0.000
2.4: 0.000 0.000 0.000 0.000 0.000 0.000 0.000 0.000 0.000 0.000 0.001 0.989 0.000 0.000 0.003 0.005
----------------------------------------------------------------------------------------------------
3.1: 0.002 0.001 0.001 0.001 0.000 0.003 0.001 0.004 0.048 0.024 0.427 0.208 0.009 0.070 0.178 0.022
3.2: 0.107 0.001 0.007 0.000 0.006 0.000 0.005 0.001 0.187 0.002 0.678 0.001 0.002 0.001 0.001 0.001
3.3: 0.001 0.002 0.003 0.003 0.006 0.000 0.000 0.012 0.002 0.000 0.002 0.025 0.006 0.008 0.081 0.849
3.4: 0.422 0.003 0.014 0.001 0.002 0.000 0.000 0.000 0.547 0.005 0.003 0.000 0.000 0.000 0.001 0.001
----------------------------------------------------------------------------------------------------
----------------------------------------------------------------------------------------------------

### Logic Operator Probabilities in the Late in the Training the Neural Network, i.e., After Convergence

----------------------------------------------------------------------------------------------------
----------------------------------------------------------------------------------------------------
1.1: 0.000 0.000 0.718 0.281 0.000 0.000 0.000 0.000 0.000 0.000 0.000 0.000 0.000 0.000 0.000 0.000
1.2: 0.000 0.000 0.000 0.000 0.000 0.000 0.000 0.000 0.000 0.000 0.736 0.264 0.000 0.000 0.000 0.000
1.3: 0.000 0.000 0.000 0.000 0.334 0.666 0.000 0.000 0.000 0.000 0.000 0.000 0.000 0.000 0.000 0.000
1.4: 0.000 0.000 0.000 0.000 0.000 0.000 0.005 0.426 0.000 0.000 0.000 0.000 0.000 0.000 0.549 0.020
----------------------------------------------------------------------------------------------------
2.1: 0.000 0.000 0.000 0.000 0.008 0.000 0.000 0.000 0.000 0.000 0.000 0.000 0.988 0.000 0.003 0.000
2.2: 0.000 0.000 0.000 0.000 0.000 0.000 0.000 0.000 0.000 0.000 0.000 0.000 0.018 0.982 0.000 0.000
2.3: 0.000 0.000 0.000 0.000 0.000 0.000 0.000 0.000 0.000 0.006 0.000 0.000 0.000 0.994 0.000 0.000
2.4: 0.000 0.000 0.000 0.000 0.000 0.000 0.000 0.000 0.000 0.000 0.004 0.004 0.000 0.000 0.991 0.001
----------------------------------------------------------------------------------------------------
3.1: 0.000 0.000 0.000 0.000 0.000 0.000 0.000 0.000 0.000 0.000 0.999 0.001 0.000 0.000 0.000 0.000
3.2: 0.000 0.000 1.000 0.000 0.000 0.000 0.000 0.000 0.000 0.000 0.000 0.000 0.000 0.000 0.000 0.000
3.3: 0.000 0.000 0.000 0.000 0.000 0.000 0.000 0.000 0.000 0.000 0.000 0.000 0.000 0.000 0.000 1.000
3.4: 0.000 0.000 0.000 0.000 0.000 0.771 0.000 0.000 0.000 0.000 0.000 0.000 0.000 0.229 0.000 0.000
----------------------------------------------------------------------------------------------------
----------------------------------------------------------------------------------------------------

The neuron of FIG. 1 corresponding to each row of the logic operator probabilities shown above is provided at the beginning of the row. For example, the row beginning with “1.1” shows values for the neuron 1.1 in the layer 103. Each column in a of the rows of logic operator probabilities corresponds to a successive ID in table 2. For example, column one of the logic operator probabilities corresponds to ID 0 of table 2 and column two of the logic operator probabilities corresponds to ID 1. Accordingly, in the middle of training, the highest probability for neuron 3.2 is 0.678, which corresponds to ID 10 of table 2, i.e., the real-valued operator 1−B.

The middle of training may refer to the number epochs the network is trained. Hence, the middle of training may refer to about half of the number of epochs. Similarly, late in training may refer to an epoch within 10% of the final epoch. For example, if the neural network is trained for 200 epochs then the middle of training may be between epoch 90 and 110. Similarly, late in training may be between epoch 190 and epoch 200. Convergence may refer to a stage of training in which additional training will not improve the neural network.

As can be seen from the exemplary values above, there are a number of probabilities for the logic operators between 0 and 1 for each neuron in the middle of training. However, after convergence, typically only one or two of the probabilities have a value other than 0 and at least one value is close to 1.

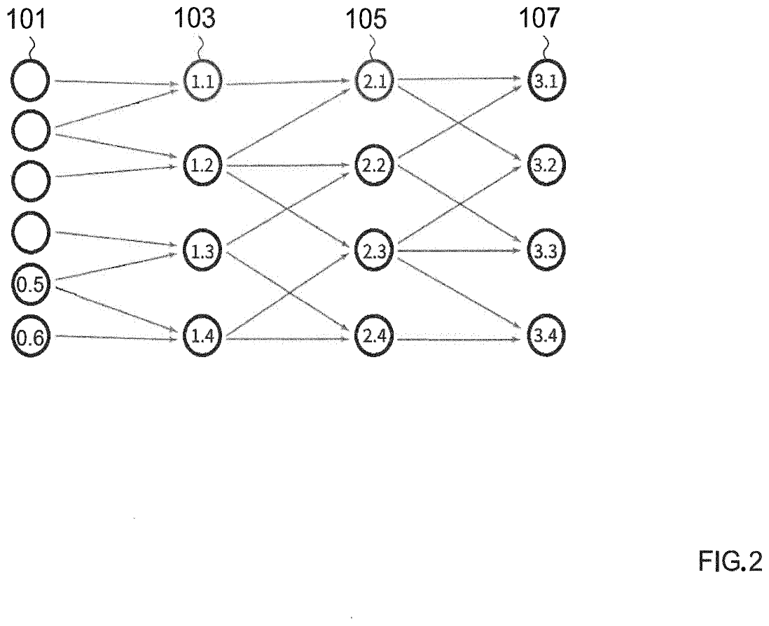

FIG. 2 shows a neural network for performing a regression task. In this case, instead of “class 0” or “class 1”, the outputs of the neural network are values of the output layer 107. More specifically, the outputs may be an array of Boolean values (i.e., a vector of values in which each value may be either a 0 or a 1). Alternatively, there may be a scalar output.

More specifically, to produce (i.e., predict) a k-dimensional output there may be n neurons in the output layer 107. The output may be grouped into k groups (e.g., of size n/k). For each dimension i of the output (prediction), there may be a scalar parameter ∝ᵢ such that ∝ᵢ·n/k is valid and provides a determined (desired) range for the output (predictions).

For example, when the regression task is to predict rainfall, there may be 1 dimension, whereas when the regression task is to predict rainfall and wind speed there may be two dimensions. The determined range for rainfall may be 0 to 200 mm. In another example, when the regression task is image generation, k may be the number of pixels; hence, to generate a 784 pixel image, k may be 784.

A final output may be determined by counting the 1 values of output neurons in the output layer 107.

In order to produce output with both positive and negative values, a bias βᵢ may be used to shift the determined range (i.e., the output space). Accordingly, the final output may be determined by counting the output neurons and applying an affine transformation, as shown in the following:

$${\hat{y}}_{i} = {∝}_{i} \cdot {\sum }_{j = 1 \cdot \frac{n}{k} + 1}^{( i + 1 ) \cdot n / k} ( {o}_{j} ) + {β}_{i} \qquad ( Equation 1 )$$

The affine transformation may be used to transform (or shift) the determined range from 0 to n/k to an application specific range that is more suitable.

In some cases, all dimensions of the output have the same range, so α=αᵢ and β=βᵢ for all i.

In some cases, it may be desirable for the determined range to cover all real numbers, which can be achieved using a logit transform, as follows:

$${\hat{y}}_{i} = logit {\sum }_{j = 1 \cdot \frac{n}{k} + 1}^{( i + 1 ) \cdot n / k} \frac{{o}_{j}}{n / k} \qquad ( Equation 2 )$$

$$where logit ( x ) = {σ}^{- 1} ( x ) = log \frac{x}{1 - x}$$

Using the output, the mean squared error (MSE) loss can be formulated as

$$ℒ = {‖ \hat{y} - y ‖}_{2}^{2} \qquad ( Equation 3 )$$

In other respects, the neural network of FIG. 2 corresponds to the neural network of FIG. 1.

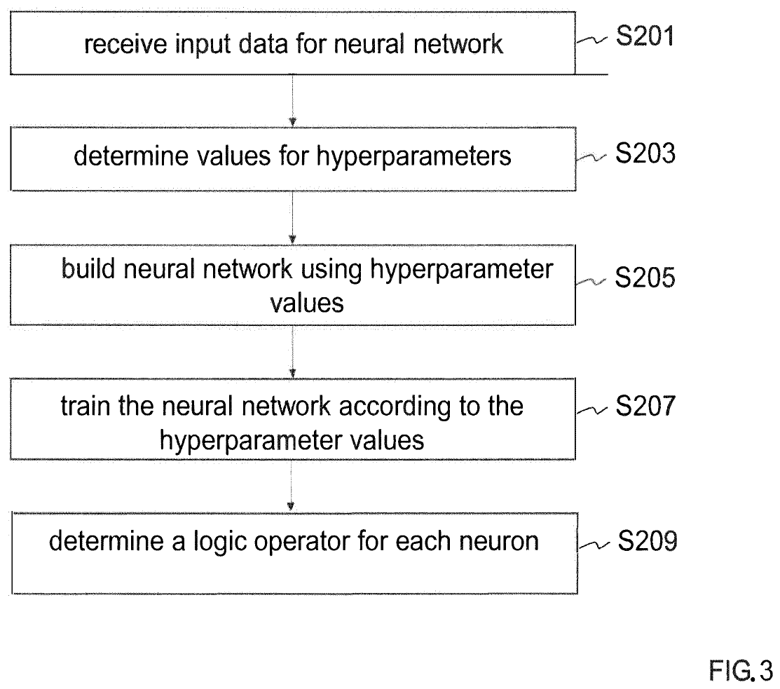

FIG. 3 shows a method for training a neural network to perform a machine learning task. The neural network may correspond to the neural networks of FIGS. 1 and 2 described above.

The neural network may be referred to as a deep differentiable logic gate network, which after training, performs all computations as binary operations on Boolean values, rather than the floating-point calculations typically performed in conventional neural networks. Operators for each neuron in the neural network may be implemented exclusively using logic gates. This may lead to a very sparse network and increased efficiency when performing the machine learning task with the trained neural network. Efficiency may be increased even further by spreading data for the machine learning task (e.g., test data) across neurons of the first layer 103.

At step S201, input data for the neural network is received. The input data may be received as binary valued inputs 101, such that each neuron in the layers 103 to 105 receives two inputs. The input data may include training data, validation data, and test data. The training data may be used to learn a probability distribution for each neuron. The validation data may be used to determine whether the neural network is sufficiently accurate, i.e., to determine whether training is complete. The test data may be used during inference (after training is complete), e.g., to evaluate the neural network against other or conventional neural networks.

At step S203, values for a plurality of hyperparameters of the neural network are determined. The hyperparameters may include a number of layers (e.g., about 2 to about 32), a number of neurons in each layer (e.g., from about 12 to about 1 024 000) and a learning rate.

For example, each layer may have the same number of neurons. In addition or alternatively, there may be about 4 to about 8 layers. This may lead to the advantage that there is no need to fine tune the architecture/structure of the neural network. Accordingly, this may simplify and speed up the determination of hyperparameters.

The learning rate may have a constant value of about 0.01.

At step S205, the neural network may be built according to the hyperparameter values. This may include generating a number of layers (e.g., 4) and a number of neurons per layer (e.g., 8000) according to the hyperparameter values. Building may include pseudo-randomly initializing connections between the neurons, i.e., the weights of the network. Other means of initializing the connections (i.e., weights) are also possible. For example, a trained neural network having weights determined according to a conventional approach may be used as a basis.

Each neuron may include a probability distribution for a plurality of logic operators. Each of the logic operators may have a signature of

$$f : \{ 0 , 1 \} x \{ 0 , 1 \} \to \{ 0 , 1 \}$$

Instead of hard binary values p−{0,1}, the probabilities of the probability distribution may be relaxed to p∈[0,1]¹⁶. This may be a step to make the neural network differentiable.

In the neural network, a single neuron may be defined as follows. The two inputs to the neuron may be defined as a, b∈[0,1]. Accordingly, p is in the probability simplex Δ¹⁵, and is a probability distribution over the logic operators. p may be parameterized via q∈ [symbol] ¹⁶, where p=softmax(q). Further, Opᵢ(⋅, ⋅) may be the real-valued logic operator with ID i according to Table 2 above. The output o of the neuron may then be defined as

$$o = {\sum }_{i = 0}^{15} {p}_{i} \cdot {Op}_{i} ( a , b ) \qquad ( Equation 4 )$$

The output o may be ∈[0,1].

By representing the choice of which logic operator (i.e., logic gate) is present in each neuron by the probability distribution (e.g., a categorical probability distribution) training can be carried out (e.g., using an algorithm based on gradient descent), since even with binary inputs the neurons in the neural network can be distinguished from each other, i.e., values in the network will no longer be restricted to ∈{0,1}.

Advantageously, storage requirements for storing the neural network may be significantly less than those for a neural network that performs floating-point operations instead of using logic operators. For example, the plurality of logic operators may consist of 16 logic operators. Accordingly, after the neural network is trained, only 4 bits are required to represent the logic operator for a given neuron. In other words, only 4 bits are required to store the information specifying the operation that a given neuron executes. This may be significantly less memory than what is required in a neural network in which the neurons perform more complex operations.

In a conventional sparse neural network, the connections between the neurons (weights) of the sparse neural network may be trained.

At step S207, the neural network may be trained according to the hyperparameter values. In contrast to the conventional sparse neural network, training the neural network may include learning which logic operator (i.e., binary function) to implement at each neuron, while the connections between the neurons remain fixed after initialization. Hence, the learning objective may be to determine which of the logic operators should be present at each neuron. Accordingly, the network may be (continuously) parameterized by learning a probability distribution for the logic operators at each neuron.

The neural network may be relaxed. In other words, instead of fixed logic operators, probability distributions of logic operators may be used and the neural network may operate on probabilities during training. Relaxing the logic operators may be another step in making the neural network differentiable. Learning the probability distribution of each neuron may be carried out via a (relaxed) softmax parameterization.

Learning the probability distribution may be implemented by parameterizing each neuron with 16 floating-point values corresponding to the 16 logic operators. Softmax may be used to map the 16 floating-point values to the probability simplex (i.e., a categorical probability distribution such that all entries add up to one and there are only non-negative values). Referring to the discussion of equation 4 above, parameterizing a neuron during initialization of the neural network may include selecting (drawing) elements of q independently from a standard normal distribution.

Training may comprise evaluating all 16 logic operators for each neuron and using the categorical probability distribution to compute their weighted average. Accordingly, during training, the outputs of all neurons may be ∈[0,1].

More specifically, for a classification task with k classes and n neurons in the output layer, the output may be grouped into k groups of size n/k. In this way, a classification score for each of the classes may be determined by counting the number of 1s in each group. Accordingly, in the context of the classification task, the output of the neural network may be determined by taking the argmax of the classification scores.

In order to determine whether the neural network is sufficiently accurate the probabilities of the outputs in each of the groups may be added up, rather than counting the number of 1s. Accordingly, a measure of accuracy may be determined by calculating classification loss. For example, a softmax cross-entropy classification loss may be calculated as follows:

$$ℒ = {\sum }_{j = 1}^{k} {y}_{j} \cdot log \frac{exp ( {\sum }_{i = j \cdot n / k + 1}^{( j + 1 ) \cdot n / k} {o}_{i} / τ )}{{\sum }_{l = 1}^{k} exp ( {\sum }_{i = l \cdot n / k + 1}^{( l + 1 ) \cdot n / k} {o}_{i} / τ )} \qquad ( Equation 5 )$$

for output neurons (oᵢ)_{i∈{1 . . . n}}, a one-hot encoding for the resulting (true) class (yⱼ)_{j∈{1 . . . k}}, and softmax temperature τ. The Adam optimization algorithm may be used for training.

After training is completed, the two inputs to the neuron may be defined as a, b∈{0,1}. Hence, in contrast to the neuron during training (see Equation 4), where the input to the neuron may be a floating-point value ≥0 and ≤1, after training the input to the neuron may be a Boolean value, i.e., either 0 or 1. Similarly, the output o of the neuron may be ∈{0,1}. Accordingly, the output o of the neuron after training may be defined as follows

$$o = {Op}_{r} ( a , b ) \qquad ( Equation 6 )$$

where r=argmaxᵢpᵢ in Equation 6. i refers to an ID in table 2.

At step S209, a logic operator may be determined for each neuron. The logic operator may be determined after training is completed, i.e., during inference. The determined logic operator may be the most likely logic operator, e.g., the logic operator of the probability distribution having the highest probability. In other words, the probability distributions may be discretized by taking their mode. Accordingly, the machine learning task can be performed by computing Boolean rather than floating-point values, thereby making classification efficient in comparison to neural networks that rely on floating point operations.

Before performing the machine learning task using the trained neural network, the neural network may be compiled into at least one binary executable. The binary executable may be processor dependent. For example, two binary executables may be compiled, one for a CPU (e.g., from C code) and one for a GPU (e.g., from CUDA).

In addition, logical expressions and/or sub-expressions may be simplified. For example, instead of Boolean data types, a hardware-implemented data type corresponding to a processor on which the machine learning task is to be performed may be used.

For example, for a 64-bit CPU, the hardware-implemented data type may be int64. In addition, an aggregation size of 64 may be used, meaning that 64 samples (e.g., images) are processed through the neural network in a given iteration (i.e., epoch). On a GPU, the output neurons may be aggregated directly using logic gates that make up the respective adders, since any writes to the GPU memory might result in a bottleneck (i.e., reduced performance). In general, bottlenecks (points in the system that may cause a reduction in speed) may be data loaders and/or transmission speed.

Accordingly, bitwise operations can be performed on larger batches, which may have a significant impact on the speed at which the machine learning task can be performed.

The output layer 107 may produce multiple outputs per class. The outputs may be aggregated via bit-counting, i.e., by counting the 1s, which yields a score for each class. Accordingly, when the machine learning task is a classification task, the classification task may be completed by providing the class with the highest score as the output of the neural network.

When performing the machine learning task with a binary vector given as input, pairs of Boolean values may be selected from the binary vector, logic operators (i.e., binary logic gates) of one of the layers (e.g., layer 103) may be applied to the Boolean values and their output can then be used for subsequent layers (e.g., layers 105 or 107) in the neural network.

After training, the computational cost of carrying out the machine learning task may be reduced by at least an order of magnitude in comparison to conventional binary and sparse neural networks and possibly even further in comparison to other types of conventional neural networks.

An exemplary machine learning task are the MONK's problems, as discussed in “The monk's problems: A performance comparison of different learning algorithms”, Thrun et al., 1991. The MONK's problems, MONK-1, MONK-2 and MONK-3, are 3 machine learning tasks that have been used to benchmark machine learning algorithms. They consist of 3 binary classification tasks on a data set with 6 attributes with 2-4 possible values each. Thus, the data points (samples) can be encoded as binary vectors of size 17.

Testing shows that the neural network discussed above performs more accurate classification than logistic regression on all three MONK data sets. In addition, for MONK-3, the neural network discussed above (i.e., of FIGS. 1 and 2) is more accurate than a much larger convolutional neural network. In addition, the neural network discussed above is at more than three times faster than logistic regression and more than seven times faster than the larger convolutional neural network. In addition, the neural network discussed above requires significantly less storage space than either logistic regression or the convolutional neural network.

As another exemplary machine learning task, the adult census (“Uci machine learning repository: Adult data set”, Kohavi et al., 1996) and breast cancer (“Uci machine learning repository breast cancer dataset”, Zwitter et al., 1988) data sets may be considered. Regarding the adult data set, the machine learning task is to predict whether a given adult makes more than $50,000 a year based on attributes such as education and hours of work per week. Regarding the breast cancer, the machine learning task includes binary classification and involves determining whether a cancer diagnosis is benign or malignant based on characteristics of a cell nucleus including perimeter, area, smoothness. For these tasks, the (classification) accuracy achieved by the neural network discussed above is comparable to the conventional (convolutional) neural network and logistic regression. In addition, classification speed is more than 10 times faster than logistic regression and more than 40 times faster than the conventional neural network. In addition, the neural network discussed above requires approximately 20% less storage space than logistic regression and about 75% less storage space than the conventional neural network.

Moreover, very high frame rates may be achieved in image classification. For example, for the neural network discussed above, frame rates in excess of one million images per second may be achieved on images of the Modified National Institute of Standards and Technology (MNIST) dataset (http://yann.lecun.com/exdb/mnist/) and the Canadian Institute For Advanced Research (CIFAR-10) dataset (“Learning Multiple Layers of Features from Tiny Images”, Alex Krizhevsky, Apr. 8, 2009). In other words, a classification rate exceeding one million images per second may be achieved using a single CPU core. This may exceed the efficiency of any conventional approach.

More specifically, the neural network discussed above may have an image classification accuracy for the MNIST dataset comparable to the fastest conventional binary neural networks, while requiring less than 10% of the number of binary operations. On a standard GPU (e.g., NVIDIA A6000), the neural network discussed above may perform 12 times faster than a conventional binary neural network on specialized FPGA hardware, even though the neural network discussed above requires only 7% utilization of the GPU. In comparison to another conventional binary neural network, the neural network discussed above may be around three orders of magnitude faster. In comparison to sparse function networks, which have been learned evolutionarily, the neural network discussed above is more accurate.

For image classification using the CIFAR-10 dataset, the accuracy of the neural network discussed above may be comparable to a conventional convolutional neural network, while requiring less than 0.1% of the memory in some cases and less than 1% of the memory in others. A specialized fully connected network may be slightly more accurate (less than 4%), however, at a cost of requiring 64% more memory.

When performing image classification using the CIFAR-10 data set, a conventional fully-connected neural network relying on floating point operations may require 2,000,000 floating point operations to perform the machine learning task while the neural network discussed above requires 5,000,000 bitwise logic operations, before pruning or optimization. On float-arithmetic hardware-accelerated integrated circuits (e.g., modern GPUs and many CPUs) the 2,000,000 floating point operations are around 100 times slower than the 5,000,000 bitwise logic operations. Without the float-arithmetic acceleration, the difference in speed would be one order of magnitude larger, i.e., the difference would be three orders of magnitude.

Even conventional sparse neural networks, while faster than the conventional fully connected neural network, are still at least an order of magnitude slower than the neural network discussed above. One sparse neural network requires at least twice as much storage space as the neural network discussed above.

Possible exemplary architectures for the neural network discussed above (in connection with FIGS. 1 and 2) are shown in the table 6 below:

TABLE 6

| | | | | Total | |
|---|---|---|---|---|---|
| | | Num. | Neurons per | number | |
| Dataset | Model | layers | layer | of p. | τ |
| MONK-1 | — | 6 | 24 | 144 | 1 |
| MONK-2 | — | 6 | 12 | 72 | 1 |
| MONK-3 | — | 6 | 12 | 72 | 1 |
| Adult | — | 5 | 256 | 1 280 | 1/0.075 |
| Breast | — | 5 | 128 | 640 | 1/0.1 |
| Cancer | | | | | |
| MNIST | small | 6 | 8 000 | 48 000 | 1/0.1 |
| | normal | 6 | 64 000 | 384 000 | 1/0.03 |
| CIFAR-10 | small | 4 | 12 000 | 48 000 | 1/0.03 |
| | medium | 4 | 128 000 | 512 000 | 1/0.01 |
| | large | 5 | 256 000 | 1 280 000 | 1/0.01 |
| | large × 2 | 5 | 512 000 | 2 560 000 | 1/0.01 |
| | large × 4 | 5 | 1 024 000 | 5 120 000 | 1/0.01 |

Table 7 shows configurations of a fully connected ReLU network that were used as a basis for comparison to the neural network configurations of table 6.

TABLE 7

| | | Num. | Neurons per | Total number of |
|---|---|---|---|---|
| Dataset | Model | layers | layer | parameters |
| MONK-1 | — | 2 | 8 | 162 |
| MONK-2 | — | 2 | 8 | 162 |
| MONK-3 | — | 2 | 8 | 162 |
| Adult | — | 2 | 32 | 3 810 |
| Breast | — | 2 | 8 | 434 |
| Cancer | | | | |
| MNIST | small | 3 | 128 | 118 282 |
| | normal | 7 | 2 048 | 22 609 930 |
| CIFAR-10 | — | 5 | 1 024 | 12 597 258 |

In addition, it may be possible to compute on average about 250 binary logic gates on each core of a CPU in each clock cycle of the CPU (i.e., per Hertz) on a typical general-purpose desktop or laptop computer. This is possible because a typical CPU executes many instructions per clock cycle even on a single core. This may be significantly faster than what is possible when executing neural networks relying on floating point operations. Additionally, the CPU may enable data of the machine learning task to be spread across neurons of the first layer 103 by grouping bits from multiple samples (e.g., images) of the data into a single integer (e.g., an integer having the datatype int64). The grouping of bits from multiple samples into the single integer may be referred to as single-instruction multiple-data (SIMD). Additional efficiency gains might be possible using advanced vector extensions (AVX).

The computational cost of a part of the machine learning task performed by a layer with n neurons (e.g., layers 103, 105 or 107) may be O(n) including small constant costs, since only logic gates of Booleans are required (i.e., operations are performed exclusively via the logic operators and thus can be performed very efficiently). By comparison, a fully connected layer with m input neurons has a computational cost of O(n·m) with significantly higher constant costs, particularly because the fully connected layer typically requires floating-point arithmetic. Overall, performing the machine learning task using a neural network trained according to the method described with reference to FIGS. 1 and 2 may lead to an inference speed that is two orders of magnitude faster than a fully connected ReLU neural network (a neural network using an ReLU activation function). In addition, the neural network trained according to the method of FIGS. 1 and 2 may be more than 13 times faster than conventional binary neural networks and 2 to 3 orders of magnitude faster than the theoretical speed of conventional sparse neural network.

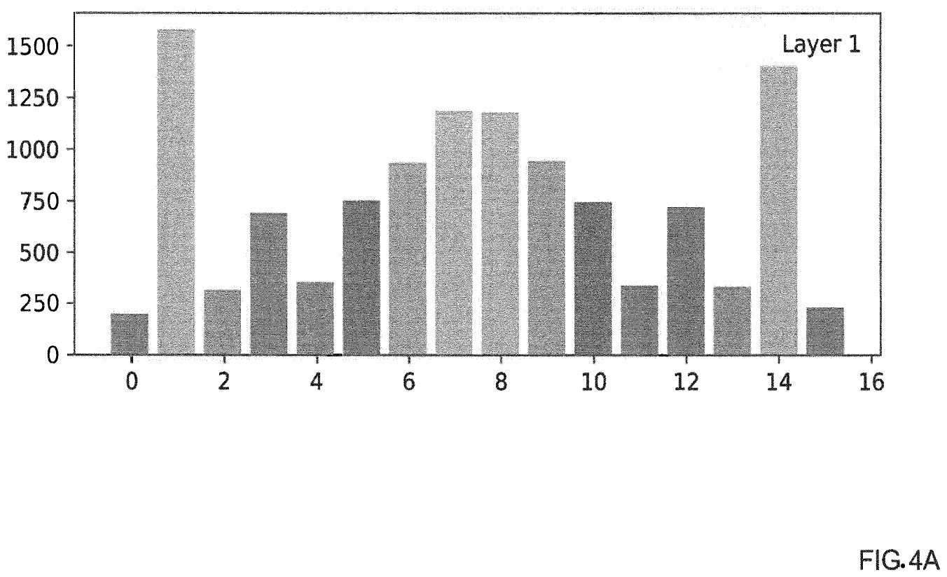

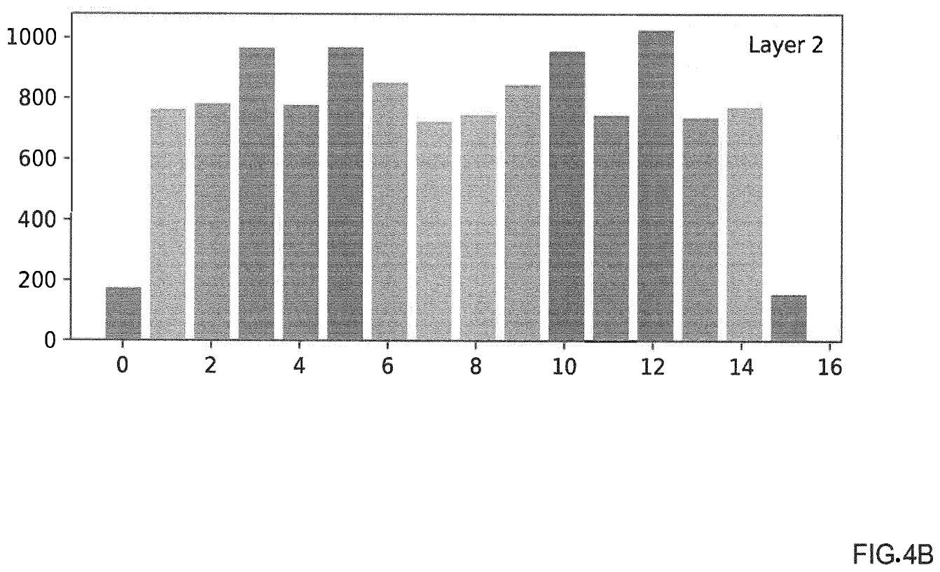

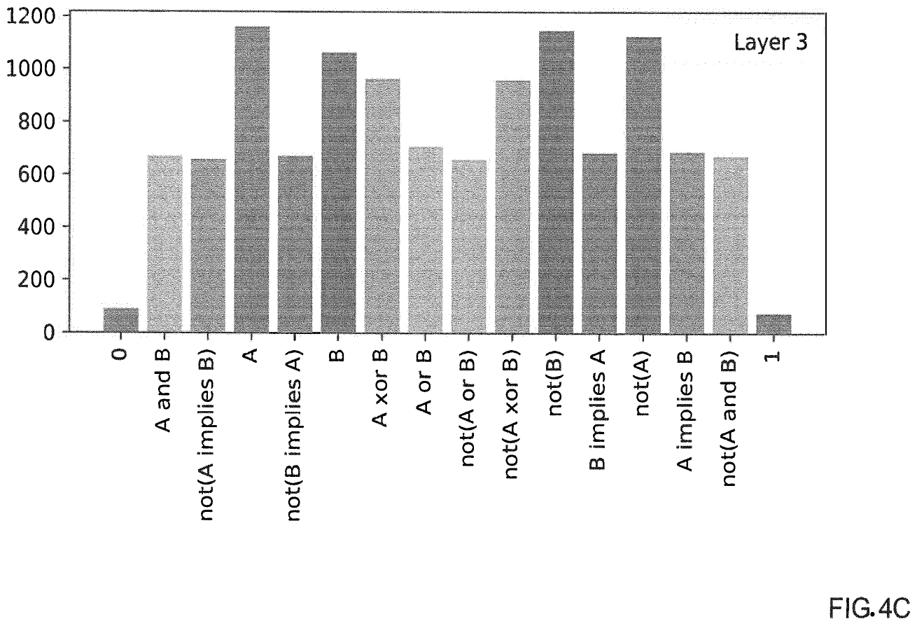

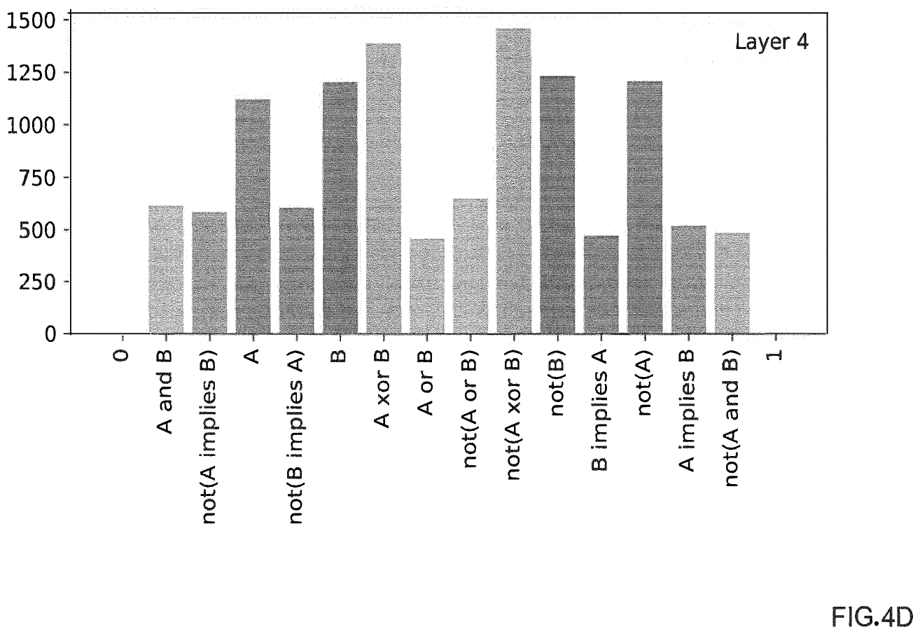

FIG. 4 shows a distribution of logic gates on the neural network once it has been trained to perform the machine learning task. In this case, the machine learning task includes image classification. The neural network has four layers with 12,000 neurons per layer. For layers 1 and 2, the values on the X axis correspond to the IDs in table 2 as well as the values on the X axis for layers 3 and 4. The values on the Y axis provide a count of the number of neurons in which the logic operator on the X axis is present.

From FIG. 4 it can be seen that the logic operators for the constants “0” and “1” (corresponding to IDs 0 and 15 in table 2) are used very infrequently and do not occur at all in layer four. In the 1st layer, “and”, “nand”, “or”, and “nor” have relatively strong probabilities.

In the 2nd and 3rd layers, there are more occurrences of “A”, “B”, “¬A”, and “¬B”, which can be seen as a residual direct connection, since one of the two inputs is ignored and the other input is fed forward (possibly in modified form) to the next layer. This may enable the neural network to model lower order dependencies more efficiently by expressing them with fewer layers than the predefined number of layers.

In layer 4, the most frequent operations are “xor” and “xnor”, which can create conditional dependencies of activations of previous layers. As shown, the implications are infrequently used. However, testing has shown that using only a proper subset of the logic operators (rather than all 16 operators of the probabilistic interpretation of table 2) may lead to decreased accuracy.

1. A method for training a logic gate neural network, comprising:
receiving, at a computing system, a training data set of input vectors and corresponding target output values;
instantiating, in a memory of the computing system, an untrained logic gate network with a plurality of nodes, wherein each node is parameterized by a set of differentiable parameters corresponding to a predefined set of potential logic gate operators;
iteratively training the logic gate network via a plurality of training iterations, each training iteration including:
forward-propagating a batch of the input vectors through the logic gate network to generate a training network output by, for each node, computing a differentiable output that is a function of the outputs of the potential logic gate operators of the respective node according to current differentiable parameters thereof;
computing a loss value that quantifies a difference between the training network output and the corresponding target output values;
determining, via a training optimization algorithm, updated differentiable parameters for at least one node; and
applying the updated differentiable parameters to at least one node; and
generating, after completion of the plurality of training iterations, a fixed logic gate network by identifying a single logic gate from the set of potential logic gate operators for a plurality of the nodes based on the differentiable parameters thereof.

2. The method of claim 1, wherein each training iteration further comprises:
aggregating groups of outputs through summation to obtain scores for use in computing the loss values.

3. The method of claim 1, wherein training the logic gate network further comprises training two or more successive layers of nodes preceding summation of bits.

4. The method of claim 1, wherein each node in the untrained logic gate network receives two input signals and produces a single output signal.

5. The method of claim 1, wherein the set of potential logic gate operators includes at least one of AND logic gate operators, OR logic gate operators, NAND logic gate operators, NOR logic gate operators, and XOR logic gate operators.

6. The method of claim 1, wherein the set of potential logic gate operators includes at least one of constant TRUE logic gate operators, constant FALSE logic gate operators, and inverter logic gate operators.

7. The method of claim 1, wherein the set of potential logic gate operators includes direct connections.

8. The method of claim 1, wherein the training optimization algorithm determines the updated differentiable parameters by:
calculating gradients of the loss value with respect to the differentiable parameters of the nodes; and
using an optimization algorithm based on gradient-descent to determine the updated differentiable parameters.

9. The method of claim 8, wherein the gradient-descent optimization computes the gradients by performing backpropagation through the logic gate network.

10. The method of claim 9, wherein the set of potential logic gate operators includes at least one direct connection.

11. The method of claim 10, wherein the set of potential logic gate operators includes at least one of AND logic gate operators, OR logic gate operators, NAND logic gate operators, NOR logic gate operators, and XOR logic gate operators.

12. The method of claim 11, wherein the set of potential logic gate operators includes at least one of constant TRUE logic gate operators, constant FALSE logic gate operators, and inverter logic gate operators.

13. The method of claim 1, further comprising:
simplifying a logical expression or logical sub-expressions of the fixed logic gate network.

14. The method of claim 1, further comprising:
storing, in a non-transitory computer-readable medium, data defining the fixed logic gate network for subsequent use with other input vectors.

15. The method of claim 1, further comprising:
implementing a logical expression of the fixed logic gate network in a field-programmable gate array (FPGA) for subsequent use with other input vectors.

16. The method of claim 1, further comprising:
implementing a logical expression of the fixed logic gate network in an application-specific integrated circuit (ASIC) for subsequent use with other input vectors.

17. The method of claim 1, further comprising:
implementing a logical expression of the fixed logic gate network in an application-specific integrated circuit (ASIC) customized to function as a tensor processing unit (TPU).

18. An application-specific integrated circuit (ASIC) with a logic gate neural network, comprising:
logic circuitry implementing a logical expression of a fixed logic gate network determined by training a differentiable logic gate neural network,
wherein, during training of the differentiable logic gate neural network, (i) each node of the differentiable logic gate network is parameterized by a set of differentiable parameters corresponding to a respective set of potential logic gate operators, (ii) each node receives inputs, and (iii) each node produces an output, and
wherein the training identifies a single logic gate operator from the set of potential logic gate operators for each respective node based on updated differentiable parameters determined during training.

19. The integrated circuit of claim 18, wherein the logic circuitry includes bit adders that compute integer output scores.

20. The integrated circuit of claim 18, wherein the logical expression of the fixed logic gate network comprises a simplified logical expression of the fixed logic gate network.

21. The integrated circuit of claim 18, wherein the logic circuitry implements the logical expression of the fixed logic gate network using fixed combinational standard-cells.

22. The integrated circuit of claim 18, wherein the ASIC is customized to function as a tensor processing unit (TPU).

23. The integrated circuit of claim 18, wherein the set of logic gate operators includes one or more of AND logic gate operators, OR logic gate operators, NAND logic gate operators, NOR logic gate operators, and XOR logic gate operators.

24. The integrated circuit of claim 18, wherein the set of potential logic gate operators includes at least one of constant TRUE logic gate operators, constant FALSE logic gate operators, and inverter logic gate operators.

25. The integrated circuit of claim 18, wherein the set of potential logic gate operators includes direct connections.

26. A neural network device comprising:
a field-programmable gate array (FPGA) that includes a programmable logic fabric; and
configuration memory storing configuration data to program the programmable logic fabric of the FPGA to implement a logical expression of a fixed logic gate network determined by training a differentiable logic gate neural network,
wherein, during training of the differentiable logic gate neural network, (i) each node of the differentiable logic gate network is parameterized by a set of differentiable parameters corresponding to a respective set of potential logic gate operators, (ii) each node receives inputs, and (iii) each node produces an output, and
wherein the training identifies a single logic gate operator from the set of potential logic gate operators for each respective node based on updated differentiable parameters determined during training.

27. The neural network device of claim 26, wherein the programmable logic fabric is configured to implement bit adders that compute integer output scores.

28. The neural network device of claim 26, wherein the set of logic gate operators includes one or more of AND logic gate operators, OR logic gate operators, NAND logic gate operators, NOR logic gate operators, and XOR logic gate operators.

29. The neural network device of claim 26, wherein the set of potential logic gate operators includes at least one of constant TRUE logic gate operators, constant FALSE logic gate operators, and inverter logic gate operators.

30. The neural network device of claim 26, wherein the set of potential logic gate operators includes direct connections.
